(19) United States
(12) Patent Application Publication
(10) Pub. No.: US 2016/0255298 A1
(43) Pub. Date: Sep. 1, 2016

(54) INSTRUCTION MODE SWITCHING METHOD AND DEVICE BASED ON SMART TELEVISION INTERFACE

(71) Applicant: LE SHI ZHI XIN ELECTR4ONIC TECHNOLOGY (TIANJIN) LIMITED, Beijing (CN)

(72) Inventors: Shangliang CI, Beijing (CN); Jia LIU, Beijing (CN); Fan LIANG, Beijing (CN)

(21) Appl. No.: 15/033,588

(22) PCT Filed: Oct. 22, 2014
(86) PCT No.: PCT/CN2014/089201

§ 371 Date: Apr. 29, 2016

(30) Foreign Application Priority Data
Oct. 30, 2013 (CN) 201310530871.X

(51) Int. Cl. H04N 5/445; G06F 3/0482; H04L 29/08

(52) U.S. Cl. CPC H04N 5/44582; H04L 67/025; G06F 3/0482; H04N 2005/4444

(57) ABSTRACT

Instruction mode switching method and device based on smart TV interface, the method includes: receiving requesting information to switch the smart TV interface to a target interface, analyzing said requesting information to know said target interface, acquiring the arrangement of options in said target interface and judging whether said arrangement satisfies a preset arrangement rule of focus mode where the smart TV is switched to said target interface and the operation of said target interface is executed by means of said focus mode if yes, otherwise, the smart TV is switched to said target interface and the operation of said target interface is executed by means of air mouse mode. With this method, the arrangement of options in various interfaces are based to select the corresponding operating mode to adapt the operating mode to the arrangement of the interface options and to the habit of user of operating different interfaces.

The present disclosure is a national stage of International Application No. PCT/CN2014/089201, filed Oct. 22, 2014, which claims the priority to China patent application submitted to China Patent Office on Oct. 30, 2013 with the application number of 201310530871.X and the title of “Instruction mode switching method and device based on smart Television interface”, the entire contents of which are incorporated herein by reference.

### FIELD OF TECHNOLOGY

The present disclosure generally relates to the field of smart TV, especially a method and instruction mode switching method and device based on a smart TV interface.

### BACKGROUND

TV is the most common household appliance in modern society. As the development of science and technology, the smart TV installed with fully-open platform and operating system also emerges at a right moment. A user can use the smart TV to enjoy the ordinary TV contents and also install and download various application software by oneself. The functionalities of the smart TV can be expanded and updated continuously and bring a rich personalized experience for the user.

Until now, the smart TV is usually operated by means of focus mode or air mouse mode. The focus mode is an operating mode to display on the screen of smart TV by means of focus frame where a remote control is used to press the keys Up, Down, Left or Right to adjust the position of the focus frame on the interface so as to move the focus frame to a target position. The air mouse mode is an operating mode to display on the screen of smart TV by means of pointer where a user can click a direction key once to move the pointer on TV screen with corresponding preset distance in this direction.

The smart TV is designed with several interfaces available to switch and operate. Nevertheless, the setting of current smart TVs can only allow the same operating mode for various interfaces of smart TV. Hence, there is only single operating mode in the smart TVs resulting in poor user experience.

### SUMMARY

In consideration of those, one of the purposes of the present disclosure is to provide a method and instruction mode switching device based on smart TV interface which can allow to select the appropriate operating mode as per the arrangement of options in different interfaces to adapt the operating mode to the arrangement of options in the interface and hence realize better user experience.

An instruction mode switching method based on a smart TV interface, characterized in that said method comprises:
receiving a requesting information to switch the smart TV interface to a target interface,
analyzing said requesting information to acquire said target interface,
acquiring the arrangement of options in said target interface and judging whether said arrangement satisfies the preset arrangement rule of focus mode,
if yes, switching the smart TV to said target interface and executing the operation of said target interface by means of said focus mode; otherwise, switching the smart TV to said target interface and executing the operation of said target interface by means of an air mouse mode.

In the method above, said receiving a requesting information to switch the smart TV interface to a target interface comprises:
when said target interface is a tabbed interface, said tabbed interface is the interface generated through triggering said tab button preset in the search bar of the browser interface of the smart TV, said tabbed interface comprises and display at least one tab and any tab instructs one web page,
when said tab button is triggered, receiving the requesting information to switch the current smart TV interface to said tab interface.

In the method above, said preset arrangement rule of focus mode comprises: said arrangement of options is in single row or in single column.

In the method above, when said target interface is a tabbed interface and the arrangement of tabs in said tabbed interface is in single row or in single column, said switching the smart TV to said target interface and executing the operation of said target interface by means of said focus mode, comprising:
switching said smart TV interface to said tabbed interface and displaying the individual tab and the focus frame of said tabbed interface,
generating the command of switching to focus mode and calling the mode-switching interface of remote control to send said command of switching to focus mode to the remote control so as to control said focus frame to move among said various tabs by said remote control and display the brief information of tabs.

In the method above, when said tabbed interface is the interface generated through triggering the tab button preset in the search bar on the browser interface and said tab is the tab selected by the focus frame, the brief information of displayed tab comprises: the thumbnail of said tab, the name of the web page corresponding to said tab and the web site corresponding to said tab,
when said tab is the tab selected by the focus frame, the brief information of displayed tab comprises: the thumbnail of said tab.

In the method above, when said target interface is a web interface and the arrangement of options in said web interface does not satisfy the preset arrangement rule of focus mode, said switching the smart TV to said target interface and executing the operation of said target interface by means of an air mouse mode, comprising:
switching said smart TV interface to said web interface and displaying the contents of the web page and the mouse pointer of said web interface,
generating the command of switching to air mouse mode and calling the mode-switching interface of remote control to send said command of switching to air mouse mode to the remote control so as to control said mouse pointer to move by said remote control.

An instruction mode switching device based on a smart TV interface, characterized in that: said device comprises receiving module, analysis module, acquisition module, judgment module, first switching module and second switching module,
wherein: said receiving module is configured to receive a requesting information to switch the smart TV interface to a target interface,
said analysis module is configured to analyze said requesting information to know said target interface,
acquisition module is configured to acquire the arrangement of the options in said target interface,
said judgment module is configured to judge whether said arrangement satisfies the preset arrangement rule of focus mode, if yes, triggering a first switching module, otherwise, triggering a second switching module,
said first switching module is configured to switch the smart TV to said target interface and execute the operation of said target interface by means of said focus mode,
said second switching module is configured to switch the smart TV to said target interface and execute the operation of said target interface by means of air mouse mode.

In the device above, when said target interface is a tabbed interface, said tabbed interface is one which comprises and displays at least one tab and any tab instructs one web page, when the arrangement of the tabs in said tabbed interface is in single row or in single column, said first switching module includes:
a tab switching module configured to switch said smart TV interface to said tabbed interface,
a first command generating module configured to generate a command of switching to focus mode,
a first sending module configured to call the mode-switching interface of remote control to send said command of switching to focus mode to the remote control so as to control said focus frame to move among said various tabs by said remote control,
a first display module configured to display various tabs and the focus frame of said tabbed interface as well as the brief information of said tabs.

In the device above, when said target interface is a web interface, the arrangement of options in said web interface does not satisfy the preset arrangement rule of focus mode, said second switching mode comprises:
a web page switching module configured to switch said smart TV interface to said web interface,
a second command generating module configured to generate a command of switching to air mouse mode,
a second sending module configured to call the mode-switching interface of remote control to send said command of switching to air mouse mode to the remote control so as to control said mouse pointer to move by said remote control,
a second display module configured to display the contents of the web page and the mouse pointer of said web interface.

A non-transitory computer readable recording medium having computer programs stored thereon that, when executed by one or more processors of a smart TV, cause the smart TV to perform:
receiving a requesting information to switch the smart TV interface to a target interface,
analyzing said requesting information to acquire said target interface,
acquiring the arrangement of options in said target interface and judging whether said arrangement satisfies the preset arrangement rule of focus mode,
if yes, switching the smart TV to said target interface and executing the operation of said target interface by means of said focus mode; otherwise, switching the smart TV to said target interface and executing the operation of said target interface by means of an air mouse mode.

There is further provided a smart TV based on a smart TV interface, characterized in that: the smart TV includes:
a memory having instructions stored thereon;
a processor configured to execute the instructions to perform operations, comprising: receiving a requesting information to switch the smart TV interface to a target interface,
   analyzing said requesting information to know said target interface,
acquiring the arrangement of the options in said target interface,
judging whether said arrangement satisfies the preset arrangement rule of focus mode,
   if yes, triggering a first switching module, otherwise, triggering a second switching module,
switching the smart TV to said target interface and execute the operation of said target interface by means of said focus mode,
switching the smart TV to said target interface and execute the operation of said target interface by means of air mouse mode.

The present disclosure provides an instruction mode switching method based on smart TV interface, including: receiving a requesting information to switch the smart TV interface to a target interface, analyzing said requesting information to know said target interface, acquiring the arrangement of options in said target interface and judging whether said arrangement satisfies a preset arrangement rule of focus mode where the smart TV is switched to said target interface and the operation of said target interface is executed by means of said focus mode if yes; otherwise, the smart TV is switched to said target interface and the operation of said target interface is executed by means of air mouse mode. With this method, the arrangement of options in various interfaces are based to select the corresponding operating mode to adapt the operating mode to the arrangement of the interface options and to the habit of user of operating different interfaces and hence to improve the user experience.

### BRIEF DESCRIPTION OF THE DRAWINGS

In order to illustrate technical solutions in the present disclosure more clearly, hereinafter, the Figures which need to be used in describing the embodiments hereinbelow are introduced briefly. Obviously, the Figures described hereinbelow are only some embodiments of the present disclosure, a skilled person in the art may obtain other Figures according to these Figures below without creativity.

FIG. 1 is the flow chart of one embodiment of the instruction mode switching method based on smart TV interface according to the present disclosure.

FIG. 2 is the flow chart of another embodiment of the instruction mode switching method based on a smart TV interface according to the present disclosure.

FIG. 3 is the flow chart of one more embodiment of the instruction mode switching method based on a smart TV interface according to the present disclosure.

FIG. 4 is the structural diagram of one embodiment of the instruction mode switching device based on a smart TV interface according to the present disclosure.

FIG. 5 is the structural diagram of another embodiment of the instruction mode switching device based on a smart TV interface according to the present disclosure.

FIG. 6 is the structural diagram of one more embodiment of the instruction mode switching device based on a smart TV interface according to the present disclosure.

FIG. 7 is the flow chart of one application scenario of the instruction mode switching method based on a smart TV interface according to the present disclosure.

FIG. 8 is the schematic diagram of the browser interface of smart TV in one application scenario of the instruction mode switching method based on a smart TV interface according to the present disclosure.

FIG. 9 is the schematic diagram of the tabbed interface in one application scenario of the instruction mode switching method based on a smart TV interface according to the present disclosure.

FIG. 10 is the flow chart of one application scenario of the instruction mode switching method based on a smart TV interface according to the present disclosure.

FIG. 11 is the schematic diagram of the tabbed interface in one application scenario of the instruction mode switching method based on a smart TV interface according to the present disclosure.

FIG. 12 is the schematic diagram of the tabbed interface in one application scenario of the instruction mode switching method based on a smart TV interface according to the present disclosure.

FIG. 13 is the schematic diagram of the tabbed interface in one application scenario of the instruction mode switching method based on a smart TV interface according to the present disclosure.

FIG. 14 is the flow chart of another application scenario of the instruction mode switching method based on a smart TV interface according to the present disclosure.

FIG. 15 is the schematic diagram of the web interface in another application scenario of the instruction mode switching method based on a smart TV interface according to the present disclosure.

### DESCRIPTION OF THE EMBODIMENTS

In order to make the objective, technical solution and advantages of the embodiment of the present disclosure more clear, hereinafter, the technical solution in the embodiment of the present disclosure is illustrated clearly and completely with the accompanying drawings in the embodiment of the present disclosure. Based on the embodiment of the present disclosure, a skilled person in the art may obtain all the other embodiments without creativity, which are all in the scope of the present disclosure.

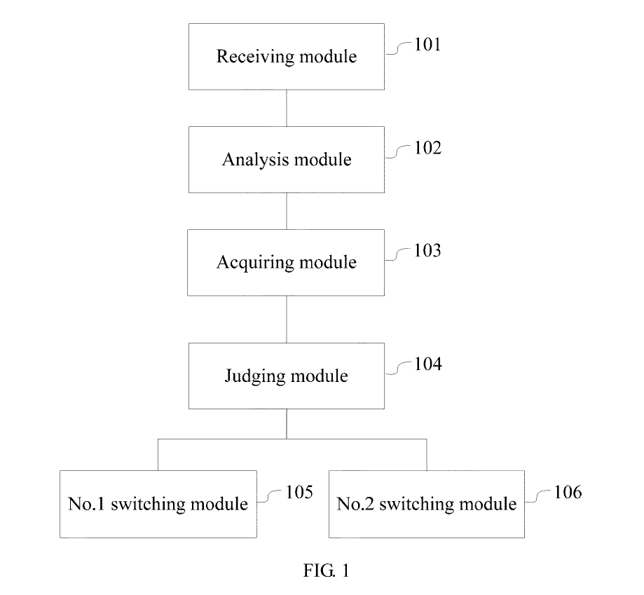

FIG. 1 shows the flow chart of the instruction mode switching method based on a smart TV interface provided by one embodiment according to the present disclosure, including:

Step S101: receiving requesting information to switch the smart TV interface to a target interface,
when a user requests to switch the interface of the smart TV, the requesting information to switch the current smart TV interface to the target interface is received. The user can use control device such as remote control or a corresponding equipment or device installed in smart TV to request switching which generates the requesting information.

Step S102: analyzing said requesting information to acquire said target interface,
the requesting information can include: various information related to switching such as the time of generating the requesting information, the target interface requested and the preset switching time, etc.

Analyzing this requesting information can know the target interface requested to switch.

Step S103: acquiring the arrangement of the options in said target interface,
the target interface can be based to get the options in the target interface and further know the arrangement of options in the target interface and acquire this arrangement.

Step S104: judging whether said arrangement satisfies the preset arrangement rule of focus mode, if yes, Step S105 is executed; otherwise, Step S106 is executed.

The arrangement is judged whether the preset arrangement rule of focus mode is satisfied. If yes, it is suitable to operate by means of focus mode in the target interface and the operation jumps to Step S105, otherwise, it is not suitable to operate by means of focus mode and the operation jumps to Step S106 to perform by means of air mouse mode.

For example, the preset arrangement rule of focus mode includes: said arrangement of options is in single row or in single column, or in no more than two rows or in no more than two columns, or in small scale of rule of the thirds (such as 3×3 format), etc. Any arrangement convenient to use focus mode can be set as the arrangement rule of focus mode.

Step S105: switching the smart TV to said target interface and executing the operation of said target interface by means of said focus mode.

Switch the interface displayed in the smart TV to the target interface, for example, when the target interface is a web interface, the interface displayed in the smart TV is switched to web interface, when the target interface is another interface, the interface displayed in the smart TV is switched to other interface. The target interface can be any interface involved in the smart TV.
when the arrangement of options in the target interface satisfies the preset arrangement rule of focus mode, it is suitable to adopt focus mode to operate in the target interface. So the focus mode is used to execute the operation in the target interface to adapt to the habit of user of operating the interface.

Step S106: switching the smart TV to said target interface and executing the operation of said target interface by means of air mouse mode.

Switch the interface displayed in the smart TV to the target interface, for example, when the target interface is a web interface, the interface displayed in the smart TV is switched to web interface, when the target interface is another interface, the interface displayed in the smart TV is switched to other interface. The target interface can be any interface involved in the smart TV.

When the arrangement of options in the target interface does not satisfy the preset arrangement rule of focus mode, it is unsuitable to adopt focus mode to operate in the target interface. So the air mouse mode can be used to execute the operation in the target interface to adapt to the habit of user of operating the interface.

In this embodiment, the arrangement of options in the target interface is based on to judge whether the preset arrangement order of focus mode is satisfied. When the order is satisfied, the operating mode of automatic switching is focus mode; otherwise, the switching is in air mouse mode. It is not limited to those above. In actual practice, before the operating mode is switched, an inquiry information can prompt to ask whether to switch the operating mode. The user can decide whether to switch the operating mode as per personal habit so as to improve the degree of involvement and realize better user experience.

In conclusion, this embodiment provides an instruction mode switching method based on a smart TV interface, including: receiving a requesting information to switch the smart TV interface to a target interface, analyzing said requesting information to know said target interface, acquiring the arrangement of options in said target interface and judging whether said arrangement satisfies a preset arrangement rule of focus mode where the smart TV is switched to said target interface and the operation of said target interface is executed by means of said focus mode if yes, otherwise, the smart TV is switched to said target interface and the operation of said target interface is executed by means of air mouse mode. With this method, the arrangement of options in various interfaces is based to select the corresponding operating mode to adapt the operating mode to the arrangement of the interface options and to the habit of user of operating different interfaces and hence to improve the user experience.

In this embodiment, the target interface is a tabbed interface that includes and displays at least one interface of tab. When the arrangement of tabs in said tabbed interface is in single row or in single column, it can be judged that the arrangement in this is a tabbed interface satisfies the preset arrangement rule of focus mode and the operation in the tabbed interface is performed by means of focus mode.

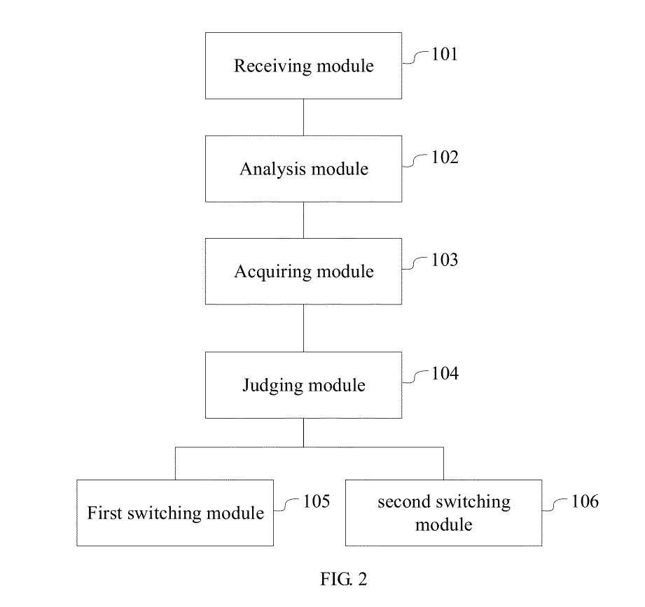

FIG. 2 shows the flow chart of the instruction mode switching method based on a smart TV interface provided by another embodiment according to the present disclosure. In this embodiment, the target interface is a tabbed interface, so Step S105 in the flow chart as shown in FIG. 1 includes specifically:

Step S1051: switching said smart TV interface to the tabbed interface and displaying the individual tab and the focus frame of said tabbed interface,

Switch the interface displayed by the smart TV to the target interface. When the target interface is a tabbed interface, the interface displayed in the smart TV is switched to the tabbed interface that includes and displays at least one tab, and any tab instructs one web page.

When the arrangement of options in the target interface satisfies the preset arrangement rule of focus mode, it is suitable to adopt focus mode to operate in the target interface. So the focus mode is used to execute the operation in the target interface to adapt to the habit of user of operating the interface.

The arrangement in the tabbed interface satisfies the preset arrangement rule of focus mode. So each tab of the tabbed interface is displayed and the focus frame indicating the focus is indicated in the tabbed interface produced from switching.

In actual practice, a tab button can be preset in the search bar of the browser interface. When the tab button is triggered, the target interface switched to is tabbed interface and the generated requesting information is the information requesting to switch the smart TV interface to the tabbed interface.

Step S1052: generating the command of switching to focus mode and calling the mode-switching interface of remote control to send said command of switching to focus mode to the remote control so as to control said focus frame to move among said various tabs by said remote control and display the brief information of tabs.

Upon switching smart TV interface, the operating mode of the smart TV is also switched to the focus mode most appropriate to the arrangement of the tabbed interface.

There is a mode-switching interface of remote control specially set in the smart TV via which the command of switching mode of remote control can be sent to the remote control.

In actual practice, the smart TV can transmit the command of switching mode of remote control to the remote control via Bluetooth.

Generate the command of switching to focus mode and call the mode-switching interface of remote control to send the command of switching to focus mode to the remote control and switch the operating mode, so as to control the focus frame to move among said various tabs by said remote control and display the brief information of tabs.

The displayed brief information of the selected tab includes: the thumbnail of the tab, the name of the web page corresponding to said tab and the web site corresponding to said tab, the displayed brief information of unselected tab includes: the thumbnail of the tabs.

When any tab is selected by the focus frame, in order to highlight the selected tab, the selected tab can be moved to the position of visual focus such as the central position of smart TV once the focus frame is moved onto the tab or the tab can show an expanded size or changed color once the focus frame is moved onto the tab. When the focus frame is moved onto other tab, this tab restores its original shape.

In this embodiment, the displayed information of the selected tab includes: the thumbnail of this tab, the name of the web page corresponding to said tab and the web site corresponding to said tab. The information is not limited to those above and in actual practice, can also include other information used to indicate the tab.

In conclusion, this embodiment provides an instruction mode switching method based on a smart TV interface. When said target interface is a tabbed interface that includes and displays at least one tab, said smart TV interface is switched to said tabbed interface and the individual tab and the focus frame of said tabbed interface is displayed. The command of switching to focus mode is generated and the mode-switching interface of remote control is called to send said command of switching to focus mode to the remote control so as to control said focus frame to move among various said tabs by said remote control and display the brief information of tabs. The operating mode in this tab interface is switched to focus mode and it is suitable for the users to select and control various tabs displayed in the tabbed interface to adapt to the operating habit of user and hence improve the user experience.

In this embodiment, the target interface is a web interface. Because there are a lot of options contained in the web interface which are arrayed in several rows and several columns, it can be judged that the arrangement in the web interface does not satisfy the preset arrangement rule of focus mode, so the operation is conducted by means of air mouse mode in the web interface.

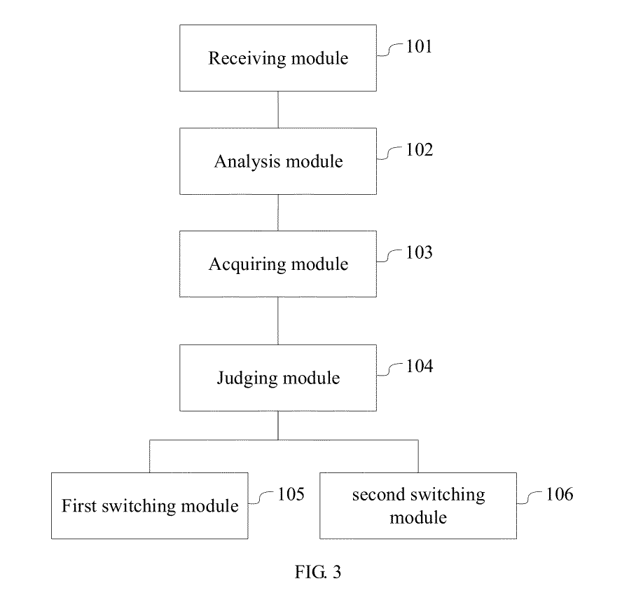

FIG. 3 shows the flow chart of the instruction mode switching method based on a smart TV interface provided by another embodiment according to the present disclosure. In this embodiment, the target interface is a web interface, so Step S106 in the flow chart as shown in FIG. 1 includes:

Step S1061: switching said smart TV interface to said web interface and displaying the contents of the web page and the mouse pointer of said web interface.

When said target interface is a web interface, the current smart TV interface is switched to the web interface and the contents of the web interface, and the most commonly used mouse pointer of the web page is displayed on the screen of the smart TV.

Step S1062: generating the command of switching to air mouse mode and calling the mode-switching interface of remote control mode to send said command of switching to air mouse mode to the remote control so as to control said mouse pointer to move by said remote control.

Upon switching smart TV interface, the operating mode of the smart TV is also switched to the air mouse mode appropriate to the arrangement of the web interface.

There is a mode-switching interface of remote control specially set in the smart TV via that the command of switching mode of remote control can be sent to the remote control.

In actual practice, the smart TV can transmit the command of switching mode of remote control to the remote control via Bluetooth.

Generate the command of switching to air mouse mode and call the mode-switching interface of remote control to send said command of switching to air mouse mode to the remote control and switch the operating mode, so as to control said mouse pointer to move on the web page by said remote control.

In conclusion, this embodiment provides an instruction mode switching method based on a smart TV interface. When said target interface is a web interface, said smart TV interface is switched to said web interface and the contents of the web page and the mouse pointer of said web interface is displayed. The command of switching to air mouse mode is generated and the mode-switching interface of remote control is called to send the command of switching to air mouse mode to the remote control so as to control said mouse pointer to move by said remote control. The operating mode in this a web interface is switched to air mouse mode and it is suitable for the users to use the mouse pointer to select the contents in the web interface to adapt to the operating habit of user and hence improve the user experience.

The present disclosure also provides a computer readable recording medium recording the program used to execute those above-mentioned methods.

Said computer readable recording medium includes any mechanism used to store in format readable by computer or carry information. For example, the machine readable media includes read-only memory (ROM), random access memory (RAM), disc storage medium, optical storage medium, flash storage medium, electric, light, sound and other formats of transmitting signal (for example, carrier wave, infrared signal, digital signal, etc.), etc.

Corresponding to the embodiments above of the instruction mode switching method based on a smart TV interface according to the present disclosure, the specification of the present disclosure also provides the embodiments of an instruction mode switching device based on a smart TV interface.

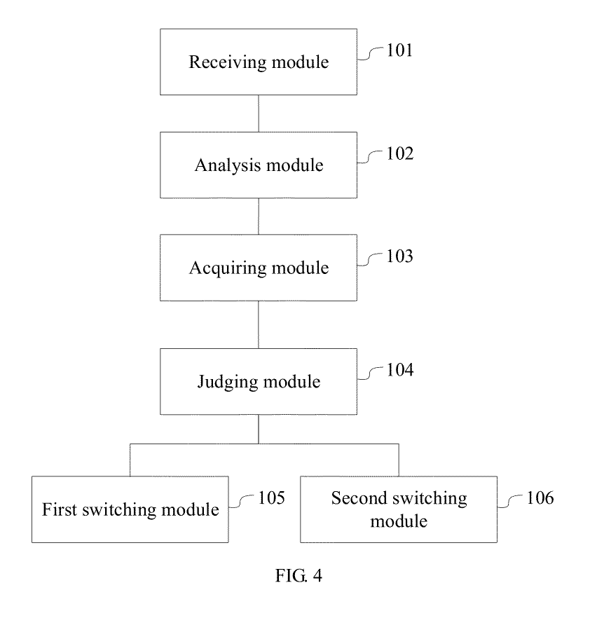

FIG. 4 shows the structural diagram of one embodiment of the instruction mode switching device based on a smart TV interface according to the present disclosure where said device includes: receiving module 101, analysis module 102, acquisition module 103, judgment module 104, first switching module 105 and second switching module 106,
wherein: said receiving module 101 is configured to receive a requesting information to switch the smart TV interface to a target interface,
if a user requests to switch the interface of the smart TV, the receiving module 101 receives the requesting information to switch the current smart TV interface to the target interface. The user can use control device such as remote control or a corresponding equipment or device installed in smart TV to request switching which generates the requesting information,
wherein: said analysis module 102 is configured to analyze said requesting information to know said target interface,
the requesting information can include: various information related to switching such as the time of generating the requesting information, the target interface requested and the preset switching time, etc.

The analysis module 102 can analyze this requesting information to know the target interface requested to switch,
wherein: the acquisition module 103 is configured to acquire the arrangement of the options in said target interface,
said judgment module 104 is configured to judge whether said arrangement satisfies the preset arrangement rule of focus mode, if yes, first switching module 105 is triggered, otherwise, second switching module 106 is triggered.

The acquisition module 103 acquires the options in the target interface as per the target interface to acquire the arrangement of the options in the target interface. The judgment module 104 judges whether the arrangement satisfies the preset arrangement rule of focus mode, if yes, it is suitable to adopt focus mode to operate in the target interface and then trigger first switching module 105, otherwise, it is not suitable to adopt focus mode to operate and then trigger second switching module 106 and adopt air mouse mode to operate.

For example, the preset arrangement rule of focus mode includes: said arrangement of options is in single row or in single column, or in no more than two rows or in no more than two columns, or in small scale of rule of the thirds (such as 3×3 format), etc. Any arrangement convenient to use focus mode can be set as the arrangement rule of focus mode,

wherein: said first switching module 105 is configured to switch the smart TV to said target interface and execute the operation of said target interface by means of said focus mode,
a first switching module 105 switches the interface displayed in the smart TV to the target interface, for example, when the target interface is a web interface, the interface displayed in the smart TV is switched to web interface, when the target interface is another interface, the interface displayed in the smart TV is switched to other interface. The target interface can be any interface involved in the smart TV.

When the arrangement of options in the target interface satisfies the preset arrangement rule of focus mode, it is suitable to adopt focus mode to operate in the target interface. So the focus mode is used to execute the operation in the target interface to adapt to the habit of user of operating the interface,

wherein: said second switching module 106 is configured to switch the smart TV to said target interface and execute the operation of said target interface by means of air mouse mode.

A second switching module 106 switches the interface displayed in the smart TV to the target interface, for example, when the target interface is a web interface, the interface displayed in the smart TV is switched to web interface, when the target interface is another interface, the interface displayed in the smart TV is switched to other interface. The target interface can be any interface involved in the smart TV.

When the arrangement of options in the target interface does not satisfy the preset arrangement rule of focus mode, it is unsuitable to adopt focus mode to operate in the target interface. So the air mouse mode can be used to execute the operation in the target interface to adapt to the habit of user of operating the interface.

In this embodiment, the arrangement of options in the target interface is based on to judge whether the preset arrangement order of focus mode is satisfied. When the order is satisfied, the operating mode of automatic switching is focus mode, otherwise, the switching is in air mouse mode, but it is not limited to those above. In actual practice, before the operating mode is switched, an inquiry information can prompt to ask whether to switch the operating mode. The user can decide whether to switch the operating mode as per personal habit so as to improve the degree of involvement and realize better user experience.

In conclusion, this embodiment provides an instruction mode switching device based on a smart TV, including: receiving module, analysis module, acquisition module, judgment module, first switching module and second switching module, wherein: said receiving module is configured to receive a requesting information to switch the smart TV interface to a target interface, said analysis module is configured to analyze said requesting information to know said target interface, acquisition module is configured to acquire the arrangement of the options in said target interface, said judging module is configured to judge whether said arrangement satisfies the preset arrangement rule of focus mode, if yes, first switching module is triggered, otherwise, second switching module is triggered, said first switching module is configured to switch the smart TV to the target interface and execute the operation of said target interface by means of said focus mode, said second switching module is configured to switch the smart TV to the target interface and execute the operation of said target interface by means of air mouse mode. With this method, the arrangement of options in various interfaces is based to select the appropriate operating mode to adapt the operating mode to the arrangement of the interface options and to the habit of user of operating different interfaces and hence to improve the user experience.

In another embodiment according to the present disclosure, the target interface is a tabbed interface that includes and displays at least one tab, and any tab instructs one web page. When the arrangement of tabs in said tabbed interface is in single row or in single column, the judgment module 104 judges that the arrangement in this a tabbed interface satisfies the preset arrangement rule of focus mode and hence first switching mode 105 is triggered to execute the operation in the tabbed interface by means of said focus mode.

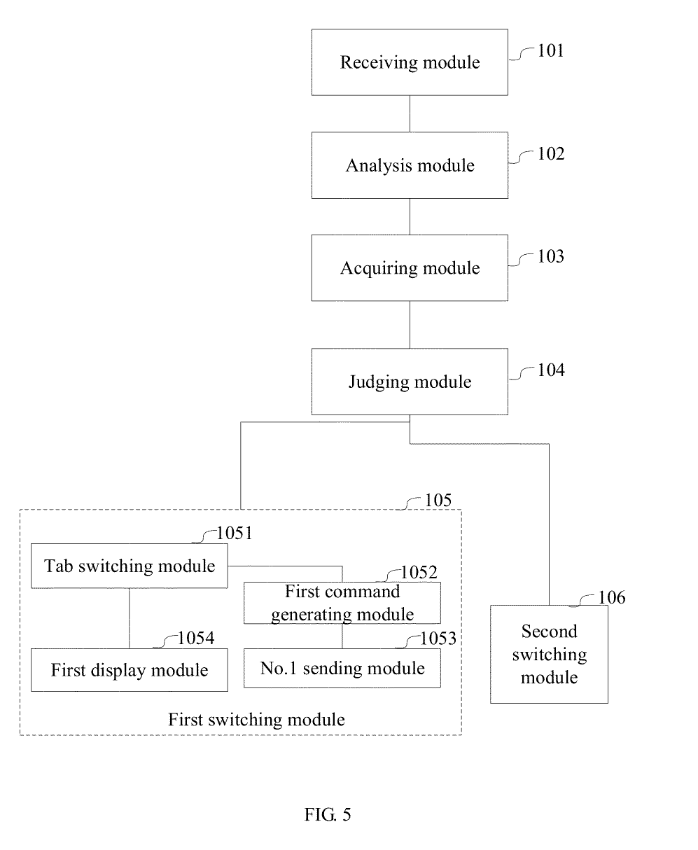

FIG. 5 shows the structural diagram of the instruction mode switching device based on a smart TV interface provided by another embodiment according to the present disclosure. In this embodiment, the target interface is a tabbed interface. Then, in the structure shown in FIG. 4, said first switching module 105 includes: tab switching module 1051, first command generating module 1052, first sending module 1053 and first display module 1054,

wherein: said tab switching module 1051 is configured to switch said smart TV interface to said tabbed interface, said first command generating module 1052 is configured to generate the command of switching to focus mode, said first sending module 1053 is configured to call the mode-switching interface of remote control to send said command of switching to focus mode to the remote control so as to control said focus frame to move among said various tabs by said remote control, first display module 1054 is configured to display the individual tab and the focus frame of said tab interface and the brief information of said tabs.

The tab switching module 1051 switches the interface displayed in the smart TV to the target interface. When the target interface is a tabbed interface, the interface displayed in the smart TV is switched to the tabbed interface.

If the arrangement of options in the target interface satisfies the preset arrangement rule of focus mode, it is suitable to adopt focus mode to operate in the target interface. So the focus mode is used to execute the operation in the target interface to adapt to the habit of user of operating the interface.

The arrangement in the tabbed interface satisfies the preset arrangement rule of focus mode. So first display module 1054 displays each tab of the tabbed interface and the focus frame indicating the position of focus in the tabbed interface produced from switching.

In actual practice, a tab button can be preset in the search bar of the browser interface. When the tab button is triggered, the target interface switched to is a tabbed interface and the generated requesting information is the information requesting to switch the smart TV interface to the tabbed interface.

Upon switching the smart TV interface, the operating mode of the smart TV is also switched to the focus mode most appropriate to the arrangement of the tabbed interface.

There is a mode-switching interface of remote control specially set in the smart TV via which the command of switching mode of remote control can be sent to the remote control.

In actual practice, the smart TV can transmit the command of switching mode of remote control to the remote control via Bluetooth.

first command generating module 1052 generates the command of switching to focus mode and first sending module 1053 calls the mode-switching interface of remote control to send the command of switching to focus mode to the remote control and switches the operating mode, so as to control the focus frame to move among said various tabs by said remote control and first display module 1054 displays the brief information of tabs.

The displayed brief information of the selected tab includes: the thumbnail of the tab, the name of the web page corresponding to said tab and the web site corresponding to said tab, the displayed brief information of unselected tabs includes: the thumbnail of the tabs.

When any tab is selected by the focus frame, in order to highlight the selected tab, the selected tab can be moved to the position of visual focus such as the central position of smart TV once the focus frame is moved onto the tab or the tab can show an expanded size or changed color once the focus frame is moved onto the tab. When the focus frame is moved onto other tab, this tab restores its original shape.

In this embodiment, the displayed information of the selected tab includes: the thumbnail of the tab, the name of the web page corresponding to said tab and the web site corresponding to said tab. The information is not limited to those above and in actual practice, can also include other information used to indicate the tab.

In conclusion, this embodiment according to the present disclosure provides an instruction mode switching device based on a smart TV. When the target interface includes and displays at least one tab, first switching module includes a tab switching module configured to switch said smart TV interface to said tabbed interface, first command generating module configured to generate the command of switching to focus mode, first sending module configured to call the mode-switching interface of remote control to send said command of switching to focus mode to the remote control so as to control said focus frame to move among said various tabs by said remote control, and first display module configured to display the individual tab and the focus frame of said tab interface and the brief information of said tabs. The operating mode in this tab interface is switched to focus mode and it is suitable for the users to select and control various tabs displayed in the tabbed interface to adapt to the operating habit of user and hence improve the user experience.

In one more embodiment according to the present disclosure, the target interface is a web interface. Because there are a lot of options contained in the web interface which are arrayed in several rows and several columns, the judgment module 104 can judge that the arrangement in the web interface does not satisfy the preset arrangement rule of focus mode, so second switching module 106 is triggered to execute the operation in the web interface by means of air mouse mode.

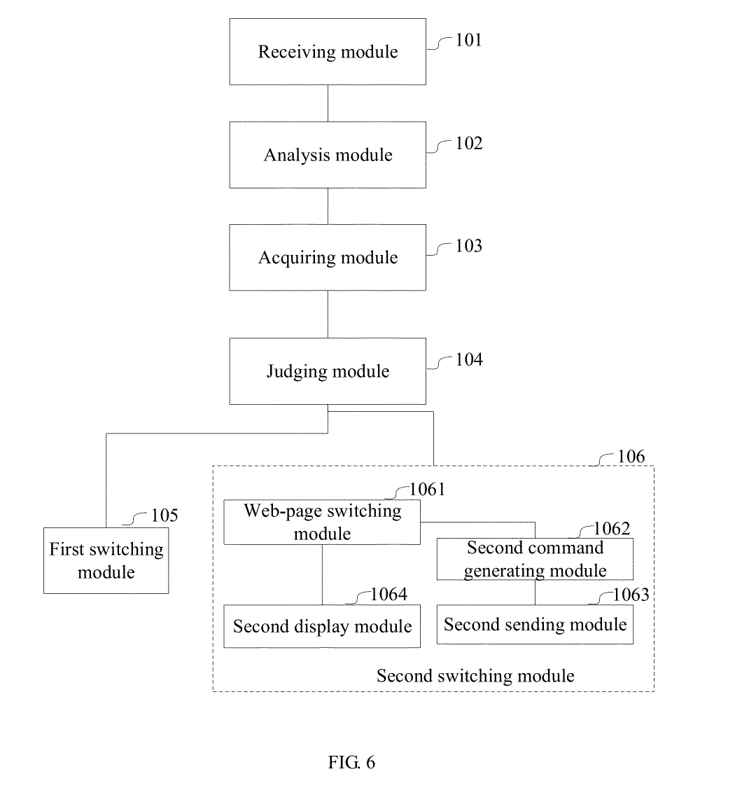

FIG. 6 shows the structural diagram of the instruction mode switching device based on a smart TV interface provided by one more embodiment according to the present disclosure. In this embodiment, the target interface is a web interface. Then, in the structure shown in FIG. 4, said second switching module 106 includes: web switching module 1061, second command generating module 1062, second sending module 1063 and second display module 1064,

wherein: said web switching module 1061 is configured to switch said smart TV interface to said web interface, said second command generating module 1062 is configured to generate the command of switching to air mouse mode, said second sending module 1063 is configured to call the mode-switching interface of remote control to send said command of switching to air mouse mode to the remote control so as to control said mouse pointer to move by said remote control, and second display module 1064 is configured to display the contents of web and the mouse pointer of said web interface.

When said target interface is a web interface, the web switching module 1061 switches the current smart TV interface to the web interface and display the contents of the web interface and the most commonly used mouse pointer of the web page on the screen of said smart TV via the second display module 1064.

Upon switching smart TV interface, the operating mode of the smart TV is also switched to the air mouse mode appropriate to the arrangement of the web interface.

There is a mode-switching interface of remote control specially set in the smart TV via which the command of switching mode of remote control can be sent to the remote control.

In actual practice, this smart TV can transmit the command of switching mode of remote control to the remote control via Bluetooth.

A second command generating module 1062 generates the command of switching to air mouse mode and second sending module 1063 calls the mode-switching interface of remote control to send said command of switching to air mouse mode to the remote control and switch the operating mode, so as to control said mouse pointer to move on the web page by said remote control.

In conclusion, this embodiment provides an instruction mode switching device based on a smart TV interface. When the target interface is a web interface, second switching module includes a web switching module configured to switch said smart TV interface to said web interface, second command generating module configured to generate the command of switching to air mouse mode, second sending module configured to call the mode-switching interface of remote control to send said command of switching to air mouse mode to the remote control so as to control said mouse pointer to move by said remote control, and second display module configured to display the contents of the web page and the mouse pointer of said web interface. The operating mode in this a web interface is switched to air mouse mode and it is suitable for the users to use the mouse pointer to select the contents in the web interface to adapt to the operating habit of user and hence improve the user experience.

The present disclosure provides the specific application scenarios of the instruction mode switching method based on a smart TV interface.

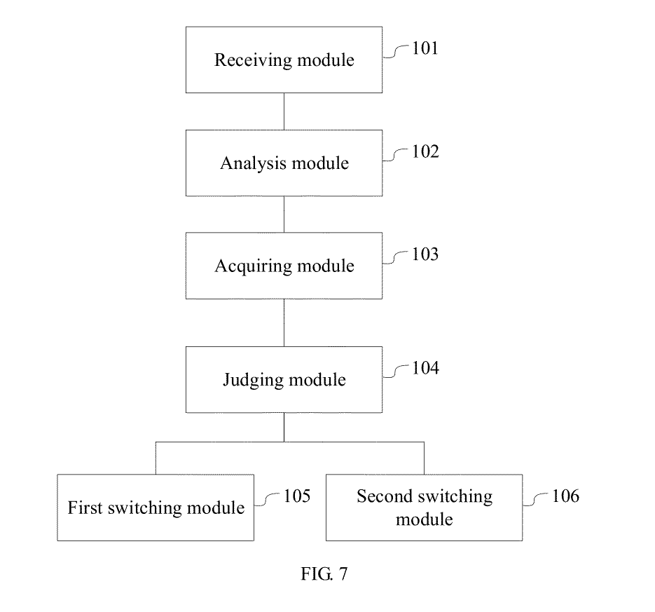

The flow chart of one application scenario is as shown in FIG. 7.

The switching in this application scenario mainly involves the switching from web interface to tabbed interface in the browser.

Step S201: click the tab button preset on the search bar of the browser of smart TV.

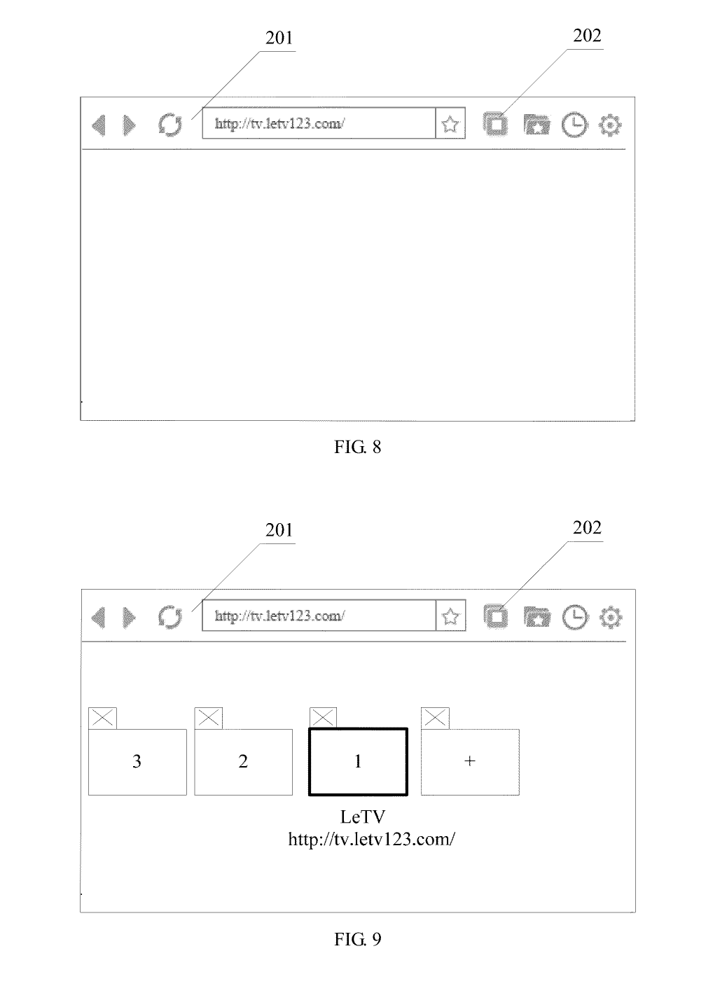

FIG. 8 shows the schematic diagram of the browser interface of smart TV where there is a tab button 202 preset on the search bar 201 of the browser of smart TV. When the tab button is triggered, the requesting information to request switching the current smart TV interface to the tabbed interface is generated.

Click the tab button to generate the requesting information to request switching the current smart TV interface to the tabbed interface. The target interface—tabbed interface includes four tabs that are arrayed in single row. As per the arrangement order of tab options in the tabbed interface, it is judged that the operating mode in the tabbed interface is focus mode.

Step S202: switch the smart TV to the tabbed interface and display the focus frame of any selected tab in said tabbed interface,

The tabbed interface obtained from switching is as shown in FIG. 9 which includes three usable tabs 1, 2 and 3 as well as one newly added page tab “+”. The four tabs are arrayed in single row where the one currently selected is 1 whose thumbnail, the name of the corresponding web page “LeTV” and the web site corresponding to said tab “http://tv.letv123.com/” are shown, other three tabs are not selected whose thumbnails are only shown.

Step S201˜S202 is the process of switching to the tabbed interface.

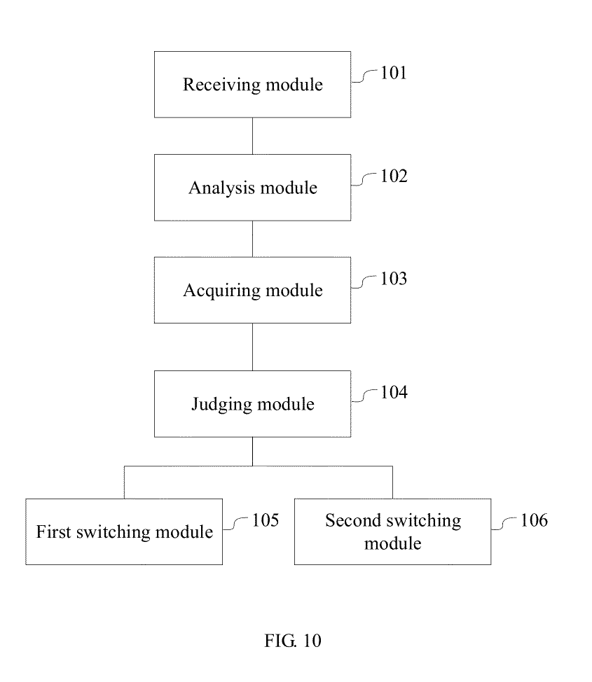

Another flow chart of the application scenario is as shown in FIG. 10.

The process to operate the tabs in the tabbed interface after entering the tabbed interface.

In this flow chart, the following steps are also included after Step S202:

Step 203: the user presses the key Left to control the focus frame to move left and select the adjacent tab.

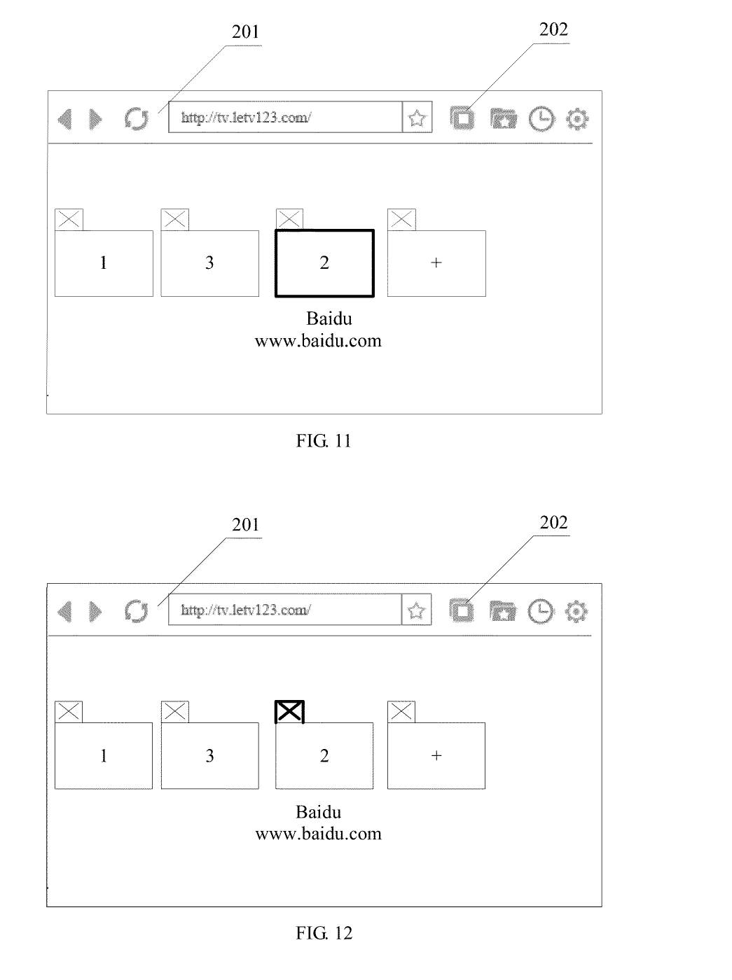

In another schematic diagram of the tabbed interface as shown in FIG. 11, the tabbed interface is one after the focus frame is moved where the one currently selected is 2 whose thumbnail, the name of “Baidu” of corresponding web page and the web site corresponding to said tab “www.baidu.com” are shown, other three tabs are not selected whose thumbnails are only shown.

Step S204: the user presses the key Up to control the focus frame to move up and select the function button “Close” of the tab, click the key “Confirm” to close the tab.

FIG. 12 shows another schematic diagram of the tabbed interface where the tab currently selected is 2 whose thumbnail, the name of corresponding web page “Baidu” and the web site corresponding to said tab “www.baidu.com” are shown, other three tabs are not selected whose thumbnails are only shown. After the user click the key Up, the focus frame is moved up to the button of closing function “X”. After the user clicks “Confirm”, the tab 2 is closed, there are total 3 tags left in the tabbed interface that are 1, 3 and the newly added tab.

Step S205: the user presses the key Right to control the focus frame to move right to the newly added tab. Then click Confirm to open the main page preset in the smart TV to add new tab.

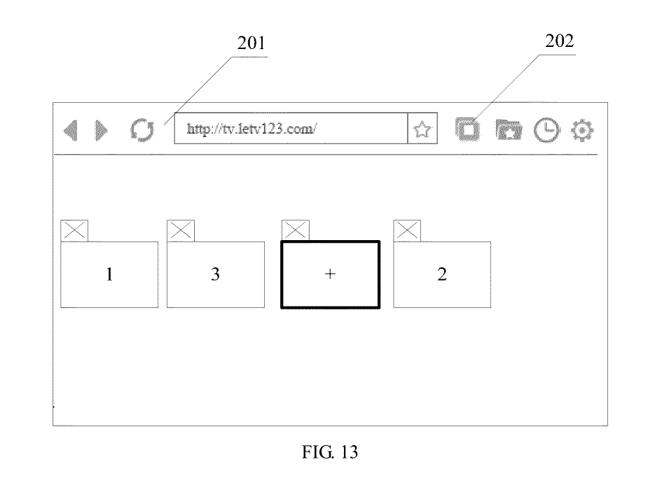

FIG. 13 shows another schematic diagram of the tabbed interface where the tab currently selected is the one newly added. Click the key Confirm to open the main page preset in the smart TV where the user can search the content and add new tab.

In this application scenarios, Step S201˜S202 is the process to switch to the tabbed interface. The following steps S203˜S205 is the process to control the movement of focus frame in the tabbed interface. In actual practice, the two processes are not bound together and either process of controlling the movement of focus frame can be implemented separately and is not bound to one another. In other application scenarios, the user can move the focus frame as per the actual demand to perform corresponding operation.

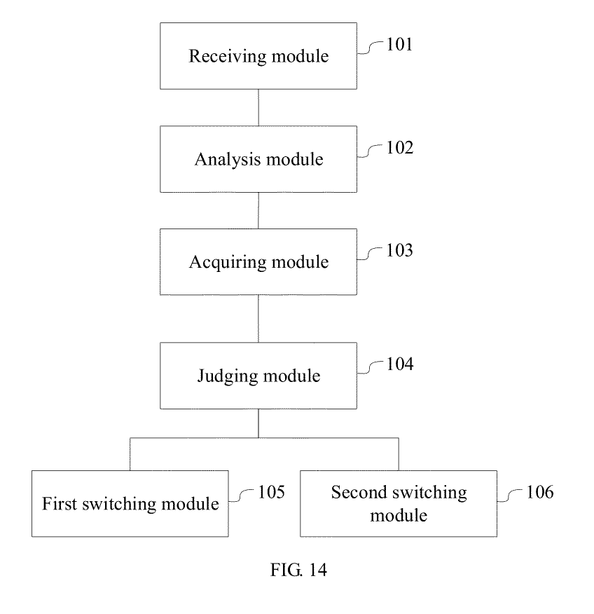

The specific flow chart of another application scenario is as shown in FIG. 14.

The switching in this application scenario mainly involves the switching from tabbed interface to web interface in the browser.

Step S301: click any tab in the tabbed interface,
the tabbed interface after the focus frame is moved is as shown in FIG. 11 where the one currently selected is 2 whose thumbnail, the name of corresponding web page and the corresponding web site are shown, other three tabs are not selected whose thumbnails are only shown.

Click the thumbnail of Tag 1 to generate the requesting information to request switching the current smart TV interface to the web interface. Because there are a lot of options contained in the web interface which are arrayed in several rows and several columns, as per the arrangement of options in the web interface, it can be judged that the arrangement in the web interface does not satisfy the preset arrangement rule of focus mode, so the operating mode adopted is air mouse mode.

Step S302: switch the smart TV to the web interface and display the contents of the web page and the mouse pointer in said web interface.

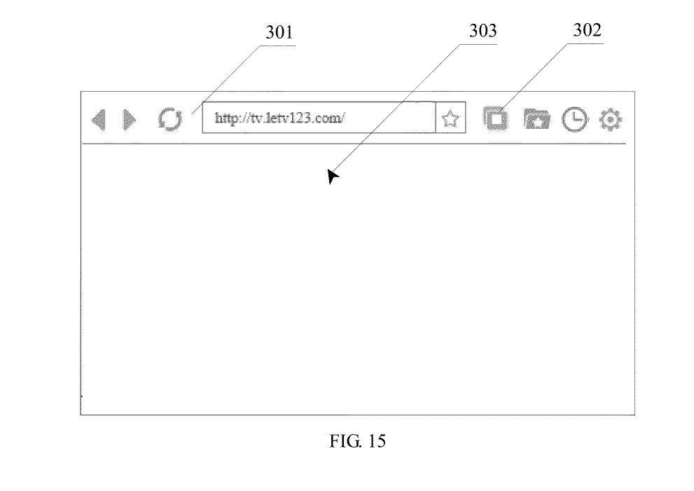

The web interface obtained from switching is as shown in FIG. 15 where there is a tab button 302 preset in the search bar 301 of the browser of smart TV and a mouse pointer 303 is displayed.

The above describes in details the method and instruction mode switching device based on a smart TV interface provided according to the present disclosure. In this paper, the specific examples are used to describe the principle and the embodiments of the present disclosure. The description on the embodiments as above is used only to help understanding the methods and its core ideas of the present disclosure; meanwhile, ordinary technical personnel skilled in the art can accord to the idea of the present disclosure to modify the concrete embodiments and the application scope. In summary, the contents in the specification shall not be understood as any limit on the present disclosure.

1. An instruction mode switching method based on a smart TV interface, characterized in that said method comprises:
receiving a requesting information to switch the smart TV interface to a target interface,
analyzing said requesting information to acquire said target interface,
acquiring the arrangement of options in said target interface and judging whether said arrangement satisfies the preset arrangement rule of focus mode,
if yes, switching the smart TV to said target interface and executing the operation of said target interface by means of said focus mode; otherwise, switching the smart TV to said target interface and executing the operation of said target interface by means of an air mouse mode.

2. The method according to claim 1, characterized in that: said receiving a requesting information to switch the smart TV interface to a target interface comprises:
when said target interface is a tabbed interface, said tabbed interface is the interface generated through triggering said tab button preset in the search bar of the browser interface of the smart TV, said tabbed interface comprises and display at least one tab and any tab instructs one web page,
when said tab button is triggered, receiving the requesting information to switch the current smart TV interface to said tab interface.

3. The method according to claim 1, characterized in that:
said preset arrangement rule of focus mode comprises: said arrangement of options is in single row or in single column.

4. The method according to claim 3, characterized in that: when said target interface is a tabbed interface and the arrangement of tabs in said tabbed interface is in single row or in single column, said switching the smart TV to said target interface and executing the operation of said target interface by means of said focus mode, comprising:
switching said smart TV interface to said tabbed interface and displaying the individual tab and the focus frame of said tabbed interface,
generating the command of switching to focus mode and calling the mode-switching interface of remote control to send said command of switching to focus mode to the remote control so as to control said focus frame to move among said various tabs by said remote control and display the brief information of tabs.

5. The method according to claim 4, characterized in that: when said tabbed interface is the interface generated through triggering the tab button preset in the search bar on the browser interface and said tab is the tab selected by the focus frame, the brief information of displayed tab comprises: the thumbnail of said tab, the name of the web page corresponding to said tab and the web site corresponding to said tab,
when said tab is the tab selected by the focus frame, the brief information of displayed tab comprises: the thumbnail of said tab.

6. The method according to claim 1, characterized in that:
when said target interface is a web interface and the arrangement of options in said web interface does not satisfy the preset arrangement rule of focus mode, said switching the smart TV to said target interface and executing the operation of said target interface by means of an air mouse mode, comprising:
switching said smart TV interface to said web interface and displaying the contents of the web page and the mouse pointer of said web interface,
generating the command of switching to air mouse mode and calling the mode-switching interface of remote control to send said command of switching to air mouse mode to the remote control so as to control said mouse pointer to move by said remote control.

7. A smart TV based on a smart TV interface, characterized in that: the smart TV comprises:
a memory having instructions stored thereon;
a processor configured to execute the instructions to perform operations, comprising:
receiving a requesting information to switch the smart TV interface to a target interface,
analyzing said requesting information to know said target interface,
acquiring the arrangement of the options in said target interface,
judging whether said arrangement satisfies the preset arrangement rule of focus mode, if yes, triggering a first switching module, otherwise, triggering a second switching module,
switching the smart TV to said target interface and execute the operation of said target interface by means of said focus mode,
switching the smart TV to said target interface and execute the operation of said target interface by means of air mouse mode.

8. The smart TV according to claim 7, characterized in that: when said target interface is a tabbed interface, said tabbed interface is one which comprises and displays at least one tab and any tab instructs one web page, when the arrangement of the tabs in said tabbed interface is in single row or in single column, the process is further configured to perform:
switching said smart TV interface to said tabbed interface,
generating a command of switching to focus mode,
calling the mode-switching interface of remote control to send said command of switching to focus mode to the remote control so as to control said focus frame to move among said various tabs by said remote control,
displaying various tabs and the focus frame of said tabbed interface as well as the brief information of said tabs.

9. The smart TV according to claim 7, characterized in that:
when said target interface is a web interface, the arrangement of options in said web interface does not satisfy the preset arrangement rule of focus mode, the processor is further configured to perform:
switching said smart TV interface to said web interface,
generating a command of switching to air mouse mode,
calling the mode-switching interface of remote control to send said command of switching to air mouse mode to the remote control so as to control said mouse pointer to move by said remote control,
displaying the contents of the web page and the mouse pointer of said web interface.

10. A non-transitory computer readable recording medium having computer programs stored thereon that, when executed by one or more processors of a smart TV, cause the smart TV to perform:
receiving a requesting information to switch the smart TV interface to a target interface,
analyzing said requesting information to acquire said target interface,
acquiring the arrangement of options in said target interface and judging whether said arrangement satisfies the preset arrangement rule of focus mode,
if yes, switching the smart TV to said target interface and executing the operation of said target interface by means of said focus mode; otherwise, switching the smart TV to said target interface and executing the operation of said target interface by means of an air mouse mode.
